(19) United States
(12) Patent Application Publication
(10) Pub. No.: US 2007/0216379 A1
(43) Pub. Date: Sep. 20, 2007

(54) POWER SUPPLY UNIT AND PORTABLE DEVICE

(75) Inventor: Atsushi Kitagawa, Kyoto (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Kyoto-shi, Kyoto (JP)

(21) Appl. No.: 11/575,980

(22) PCT Filed: Oct. 25, 2005
(86) PCT No.: PCT/JP05/19952

§ 371 Date: Mar. 26, 2007

(30) Foreign Application Priority Data
Oct. 29, 2004 (JP) 2004-315297

(51) Int. Cl. H01F 27/42; G05F 1/00

(52) U.S. Cl. 323/265

(57) ABSTRACT

A switching type power supply unit adapted to generate a positive output voltages though conversion of a power supply voltage has an negative output voltage generation circuit switchably connected, via a changeover switch, between the first node of a coil and a switch and the second node receiving the power supply voltage or between the first node and the ground. The negative output voltage generation circuit is connected to the second node when the voltage difference between the positive output voltage (Vp) and the power supply voltage (Vbat) is sufficiently large, while the circuit is connected to the ground when the difference voltage is small. Thus, the power supply unit efficiently provides a negative output voltage having a predetermined level along with a positive output voltage (Vn) generated from the power supply voltage through conversion thereof.

### BACKGROUND OF THE INVENTION

1. Field of the Invention

This invention relates to a power supply unit utilizing a switching-type power supply circuit (referred to as switching power supply circuit) that includes a coil, the power supply unit adapted to generate a negative output voltage along with a positive output voltage obtained by converting a given power supply voltage. The invention also relates to a portable device having a load that requires a positive and a negative voltage.

2. Description of the Related Art

Conventionally, switching power supply units that utilize a coil have been used as DC-DC converters for generating a voltage different from a given power supply voltage. This switching power supply unit, configured to be a step-up type unit, obtains a high voltage through on-off switching of current supplied from a DC power supply to a coil. The high voltage is then rectified and smoothed before it is provided as a positive step-up output voltage.

A switching power supply unit has been proposed in Japanese Patent Application Laid Open H10-271815 (referred to as Patent Document 1), in which the unit is coupled with a polarity inversion type output circuit to provide a negative output voltage along with a positive output voltage.

However, the prior art switching power supply unit as disclosed in the Patent Document 1 can provides a negative output voltage having a level that depends on the level of the positive output voltage. That is, in prior art power supply unit, the level of the negative output voltage is automatically determined by the level of the positive output voltage. As a consequence, the power supply unit of the Patent Document 1 cannot provide a negative output voltage having an arbitrarily prescribed level.

Although the negative output voltage of the power supply unit of Patent Document 1 can be regulated to a predetermined level if a voltage regulation circuit is used. However, such regulation will result in a problem that its electric power loss increases with the level of the voltage to be regulated.

### SUMMARY OF THE INVENTION

It is, therefore, an object of the present invention to provide a switching power supply unit capable of efficiently generating a negative output voltage having a prescribed level, along with a positive output voltage that is obtained by converting a power source voltage.

It is another object of the invention to provide a portable device equipped with a battery providing a power supply voltage, a switching power supply unit for generating a negative output voltage along with a positive output voltage converted from the power supply voltage, and a load that utilizes the positive and negative output voltage.

A power supply unit in accordance with one aspect of the invention comprises: a switching power supply 70 circuit that includes a coil L1, a switch Q1 connected in series to said coil to switch on and off the power received from a node supplying a power supply voltage Vbat (said node hereinafter referred to as power supply voltage node) to said coil, a rectifying and smoothing circuit D1 and C1 for rectifying and smoothing the voltage that appears at the serial connection node A of said coil and switch and for outputting the rectified and smoothed voltage Vp as said positive output voltage, and a control circuit 13 for controlling on-off operation of said switch so as to bring a detection voltage Vdet1 associated with said positive output voltage to a reference voltage Vref1; and a negative output voltage generation circuit 80 connected between said serial connection node A of said coil and switch and said power supply voltage node and adapted to generate a prescribed negative output voltage Vn based on said positive output voltage Vp and power supply voltage Vbat.

The negative output voltage generation circuit 80 may comprise: a series circuit connected in parallel to said switch, said series circuit including a second capacitor C2 having one end connected to the serial connection node of said coil L1 and switch Q1, a second diode D2 having a cathode connected to the other end of said second capacitor C2, and a third capacitor C3 connected to the anode of said second diode D2; and a third diode D3 having an anode connected to the node of said second diode D2 and second capacitor C2 and a cathode connected directly or indirectly to said power supplying node such that the voltage across said third capacitor C3 is outputted as said negative output voltage.

A voltage controlling transistor 21 for controlling the level of said negative output voltage may be provided between the cathode of said third diode and said power supply voltage node.

The voltage controlling transistor 21 may be controlled so as to lower the cathode voltage of said third diode D3 below said positive output voltage Vp by a predetermined voltage.

Said voltage controlling transistor 21 or may be controlled so as to bring the feedback voltage associated with said negative output voltage to a predetermined voltage.

A power supply unit in accordance with another aspect of the invention comprises: a switching power supply circuit 70 that includes a coil L1, a switch Q1 connected in series to said coil to switch on and off the power received from a power supply voltage Vbat node to said coil, a rectifying and smoothing circuit D1 and C1 for rectifying and smoothing the voltage appearing at the serial connection node A of said coil and switch and outputting the rectified and smoothed voltage as said positive output voltage Vp, and a control circuit for controlling on-off operation of said switch so as to bring a detection voltage associated with said positive output voltage to a reference voltage Vref1; and a negative output voltage generation circuit 80 switchably connected, via change-over switch circuits 23 and 24, between said serial connection node of said coil and switch and either one of said power supply voltage node and a node A (e.g. grounded node) having a stable voltage (this node referred to as stable voltage node), said negative output voltage generation circuit 80 adapted to generate a prescribed negative output voltage Vn based on said positive output voltage Vp and either one of said power supply voltage Vbat and stable voltage.

The negative output voltage generation circuit 80 may comprise: a series circuit connected in parallel to said switch, said series circuit including a second capacitor C2 having one end connected to the serial connection node of said coil L1 and switch Q1, a second diode D2 having a cathode connected to the other end of said second capacitor C2, and a third capacitor C3 connected to the anode of said second diode D2; and a third diode D3 having an anode connected to the node of said second diode and second capacitor and a cathode connected to either one of said power supplying node and a stable voltage node via said changeover switch circuits such that the voltage across said third capacitor is outputted from said cathode as said negative output voltage.

Further, a first voltage controlling transistor 21 may be provided between the cathode of said third diode and the power supply voltage node to control the level of said negative output voltage, and a second voltage controlling transistor 22 may be provided between said cathode of said third diode and said stable voltage node to control the level of said negative output voltage.

The respective first and second voltage-controlling transistors 21 and 22 may be controlled so as to lower the cathode voltage of the third diode D3 below the positive output voltage Vp by a predetermined voltage.

The respective first and second voltage controlling transistors 21 and 22 may be controlled so as to bring the feedback voltage associated with said voltage across said third capacitor C3 to a predetermined voltage.

A portable device in accordance with the present invention comprises: a power supply battery BAT for supplying a power supply voltage Vbat; any one of the power supply units as described above for generating a positive output voltage Vp and a negative output voltage Vn by converting said power supply voltage; a load that utilizes said positive and negative output voltages; and a controller for controlling said load.

The positive output voltage Vp and/or negative output voltage Vn may be supplied from said power supply unit to said load via a voltage regulator.

As described above, the present invention provides not only a predetermined positive output voltage Vp by means of a switching power supply circuit that utilizes a coil and converts a power supply voltage Vbat to the positive output voltage Vp, but also a prescribed negative output voltage Vn based on the positive output voltage Vp and the power supply voltage Vbat by means of a negative output voltage generation circuit connected between the node of the coil L1 and the switch Q1 of the power supply unit and a power supply voltage node. In this arrangement, depending on the level of the negative output voltage Vn, the electric energy associated with the excessive voltage is returned to the battery BAT for supplying a power supply voltage Vbat via the first voltage controlling transistor 21 and stored in the battery. This permits improvement of the efficiency of the power supply unit while generating a proper negative output voltage Vn.

As described above, there can be provided a negative output voltage generation circuit that is switchably connected, via a changeover switch, between the node of the coil L1 and the switch Q1 and either one of the power supply voltage node and a stable voltage node (e.g. grounded node), so that a predetermined negative output voltage Vn can be generated by the negative output generation circuit based on the positive output voltage Vp and either one of the power supply voltage Vbat and the stable voltage. Thus, the negative output generation circuit is connected to the power supply voltage node to generate an appropriate level of negative output voltage when the voltage difference between the positive output voltage Vp and the power supply voltage Vbat is sufficiently large, thereby improving the efficiency of the negative output generation circuit.

On the other hand, when the voltage difference becomes lower below a predetermined voltage due to, for example, an excessive drop of the positive output voltage Vp or an excessive rise of the power supply voltage Vbat, the negative output generation circuit is connected to the stable voltage node (e.g. grounded node) to generate a proper negative output voltage Vn. Therefore, it is possible to generate a required negative output voltage Vn under various conditions of the battery.

As described above, in order to control the level of the negative output voltage Vn, there can be provided a first voltage controlling transistor (connected to the power supply voltage Vbat node) and a second voltage controlling transistor (connected to a stable voltage node or the ground). By controlling these voltage controlling transistors in the manner as described above, a prescribed level of the negative output voltage Vn can be obtained.

It will be recalled that the first and second voltage controlling transistors may be controlled so that the cathode voltage of the third diode D3 becomes lower than the positive output voltage Vp by a predetermined voltage. That is, the first and second voltage controlling transistors can be controlled so as to charge the second capacitor C2 (serving as a polarity inversion capacitor) to a predetermined voltage. As a result, the negative output voltage Vn can be controlled to a predetermined level without resorting to feeding back the negative output voltage Vn. This arrangement allows minimization of the number of terminals of the voltage controlling IC 90.

The present invention can efficiently provide the load of a portable device such as a CCD camera with a required positive operating voltage and a required negative operating voltage, and can effectively extend the serviceable life of the battery used.

### BRIEF DESCRIPTION OF THE DRAWINGS

FIG. 1 is a diagram showing a main structure of a portable device in accordance with the invention.

FIG. 2 is a diagram showing the arrangement of a positive-negative output voltage supply unit in accordance with a first embodiment of the invention.

FIG. 3 is a diagram showing a first arrangement of the negative voltage control circuit 30 of FIG. 2.

FIG. 4 is a diagram showing a second arrangement of the negative voltage control circuit 30A of FIG. 2.

FIG. 5 is a diagram showing the arrangement of a positive-negative output voltage supply unit in accordance with a second embodiment of the invention.

FIG. 6 is a diagram showing an arrangement of the changeover control circuit 40 of FIG. 5.

FIG. 7 is a diagram showing a third arrangement of the negative voltage control circuit 30B of FIG. 2.

FIG. 8 is a diagram showing a fourth arrangement of the negative voltage control circuit 30C of FIG. 2.

### DETAILED DESCRIPTION OF PREFERRED EMBODIMENTS

An inventive power supply unit and a portable device utilizing such power supply unit will now be described in detail with reference to the accompanying drawings.

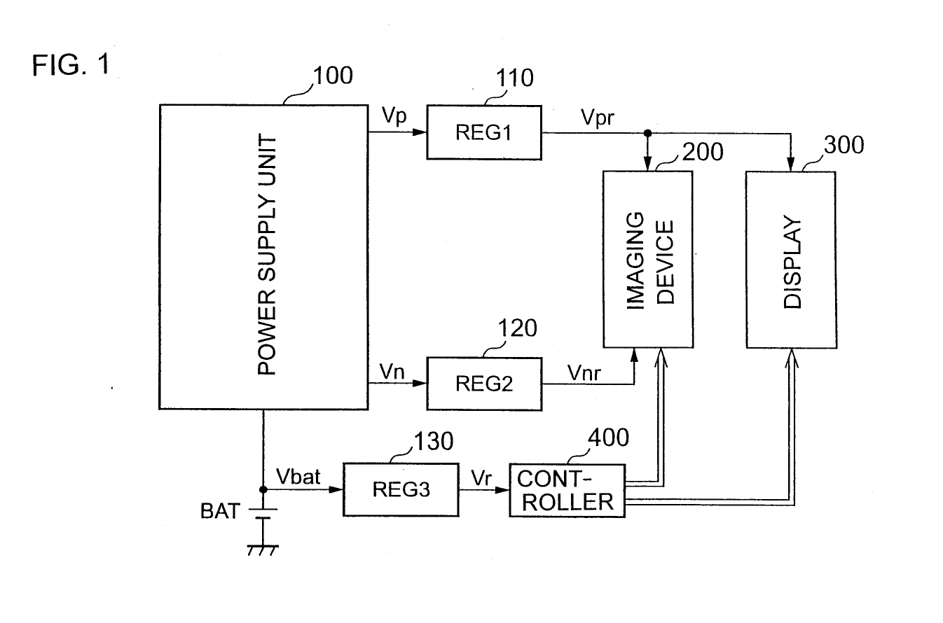

Referring to FIG. 1, there is shown a main structure of a portable device in accordance with the invention. The portable device such as a mobile telephone and a digital still camera have a load which requires a predetermined voltage of first polarity (referred to as positive voltage) and a predetermined voltage of second polarity (referred to as negative voltage).

As shown in FIG. 1, a power supply unit for providing positive-negative output voltage (hereinafter referred to as positive-negative output voltage supply unit) 100 is supplied with a power supply voltage Vbat from a power supply battery BAT and outputs a positive output voltage Vp (which is +15 V, for example) and a negative output voltage (which is −8 V, for example). A voltage regulator 110 is a series type voltage regulator, for example, which is used to change the positive output voltage Vp to another voltage level Vpr. A voltage regulator 120 is a series type voltage regulator, for example, which is used to change the negative output voltage Vn to another voltage Vnr.

Either one or both of these voltage regulators 110 and 120 may be omitted depending on the requirements for the positive voltage Vp and/or negative output voltage Vn as well as voltages Vpr and Vnr. For example, if the positive output voltage Vp is controlled to a prescribed level, but the negative output voltage Vn is not, then the voltage regulator 110 can be omitted. If each of the positive and negative output voltages, Vp and Vn, is controlled to a prescribed level, then both of the voltage regulators 110 and 120 can be omitted.

An imaging device 200 such as a CCD camera is fed with the positive and negative voltages. A display 300 has a drive circuit for driving a set of LED(s) (light emitting diode(s)), for example. A controller 400 controls operation of the portable device that includes the imaging device 200 and the display 300. The controller 400 is supplied with a voltage Vr obtained by regulating the power supply voltage Vbat with a voltage regulator 130.

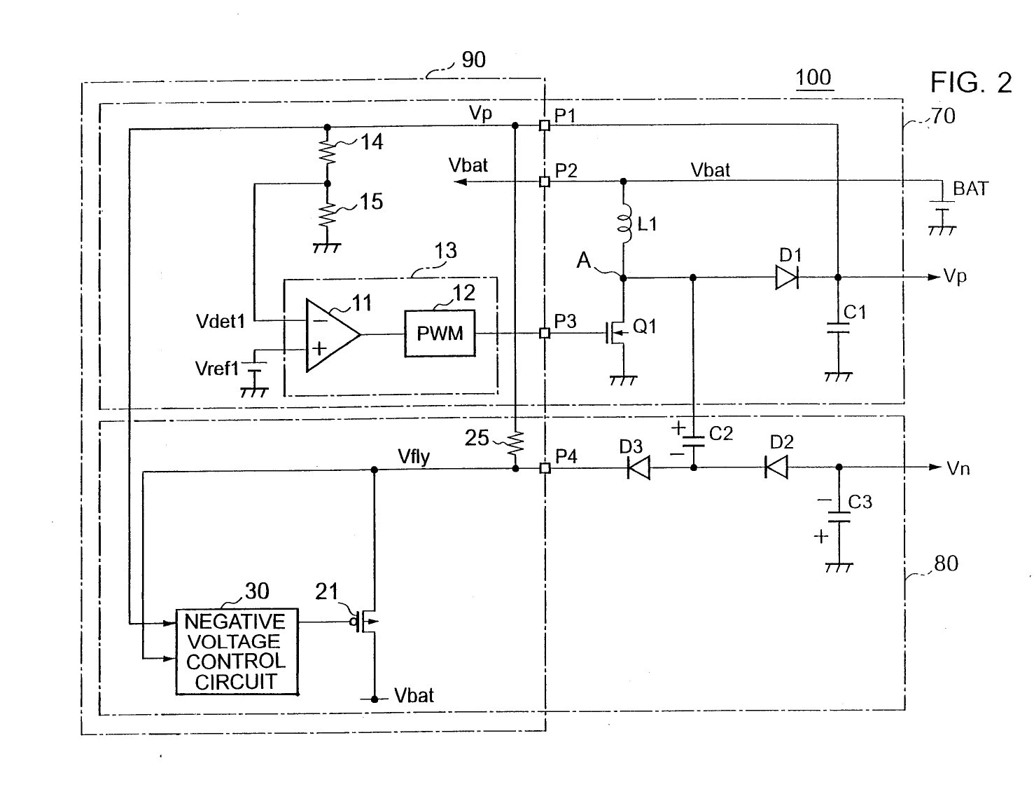

Referring to FIG. 2, there is shown an arrangement of a positive-negative output voltage supply unit 100 in accordance with a first embodiment of the invention.

As shown in FIG. 2, a switching power supply circuit 70 steps up the power supply voltage Vbat (which is 3.6 V for example) supplied from the power supply battery BAT to the positive output voltage Vp. Incidentally, the power supply battery BAT can be provided outside the power supply unit 100.

A coil L1 and a switch Q1 in the form of an N type MOS transistor, connected together in series at node A, are provided between the power supply voltage Vbat and the ground. The voltage appearing at the serial connection node A is rectified and smoothed by a first rectification diode D1 and a first smoothing capacitor C1 before it is outputted as the positive output voltage Vp. It should be understood that voltages refer to potentials with reference to the ground unless otherwise stated.

A voltage controlling IC 90 is an LSI accommodating therein mainly a control circuit of the positive-negative output voltage supply unit 100. P1-P4 represent terminals of the IC 90.

The positive output voltage Vp, inputted into the voltage controlling IC 90 from the terminal P1, is divided by voltage dividing resistors 14 and 15 to generate a first detection voltage Vdet1.

The first detection voltage Vdet1 and a first reference voltage Vref1 are inputted into a control circuit 13, which generates a switching signal for controlling switching operation of the switch Q1 so as to bring the first detection voltage Vdet1 to the first reference voltage Vref1. The control circuit 13 shown herein includes an error amplifier 11 for amplifying the difference between the first reference voltage Vref1 and first detection voltage Vdet1, and a PWM control circuit 12 for forming a PWM signal to be outputted therefrom as the switching signal, based on the output of the error amplifier 11.

The positive output voltage Vp is thus controlled by the switching power supply circuit 70 such that the power supply voltage Vbat is stepped up to a predetermined voltage. The voltage at the serial connection node A turns out to be either zero or positive output voltage Vp according to the ON or OFF status of the switch Q1. It is preferable in the invention that the diodes D1-D3 shown in FIG. 2 are Schottky barrier diodes that exhibit low voltage drops. In what follows, it should be understood that operation of the power supply unit would be often described with neglect of voltage drops across diodes.

A negative output voltage generation circuit 80 has a second capacitor C2, a second diode D2, and a third capacitor C3, all connected in series between the serial connection node A and the ground. They are connected in parallel with the switch Q1. The second diode D2 has a polarity in such a way that its cathode is connected to the second capacitor. The anode of the third diode D3 is connected to the node of the second diode D2 and the second capacitor C2.

The cathode of the third diode D3 is connected, via a first voltage controlling transistor 21 in the form of a P-type MOS transistor for controlling the voltage of the negative output voltage Vn, to a node (referred to as power supply voltage node) connected to the power supply battery voltage BAT and having the power supply voltage Vbat. The cathode of the third diode D3 is coupled to the positive output voltage Vp via a highly resistive pull-up resistor 25, so that the negative output setting voltage Vfly can be pulled up to the positive output voltage Vp. As a result, the negative output setting voltage Vfly is stably set to the positive output voltage Vp when the third diode D3 is turned off (i.e. when impressed with a reverse bias).

The first voltage controlling transistor 21 is controlled by a negative voltage control circuit 30 that is fed with the positive output voltage Vp and the cathode voltage Vfly of the third diode D3 (the cathode voltage hereinafter referred to as negative output setting voltage).

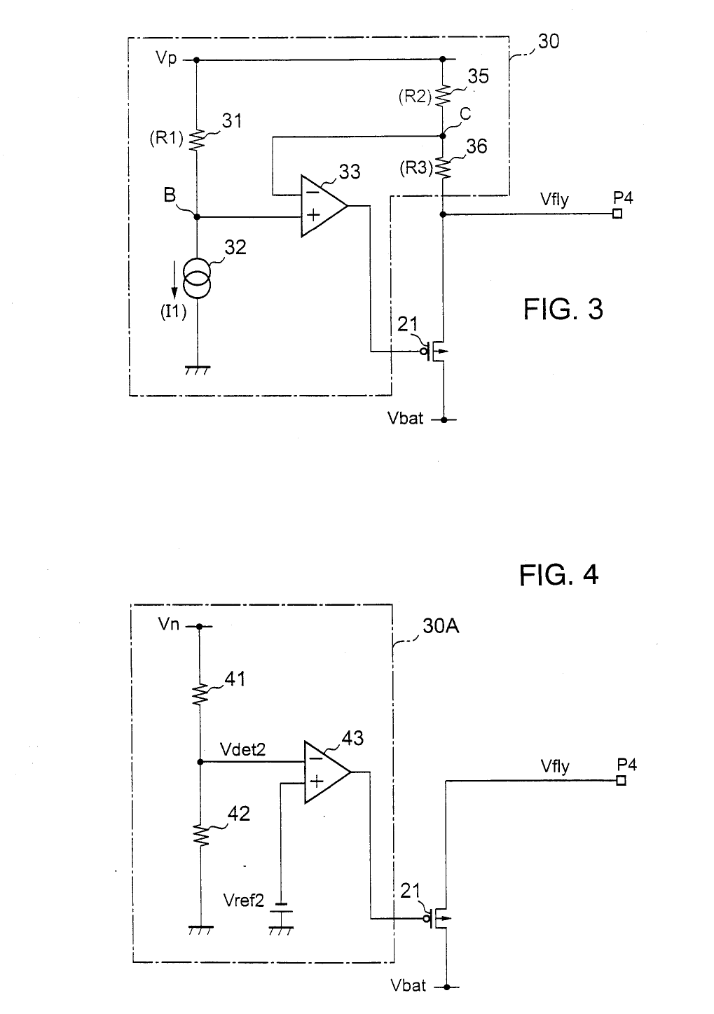

Referring to FIG. 3, there is shown a first arrangement of the negative voltage control circuit 30. As shown in FIG. 3, a resistor 31 (of resistance R1) and a constant current circuit 32 (providing constant current I1) are connected in series at a node B and between a node having the positive output voltage Vp and the ground. Provided between a node having the positive output voltage Vp and a node having the negative output setting voltage Vfly are a resistor 35 (of resistance R2) and a resistor 36 (of resistance R3) connected in series at a node C. It is noted that a certain number of Zener diodes can be used in place of the resistor 35.

An error amplifier 33 is supplied with the voltages of the node B and node C, and provides its output to the gate of the first voltage controlling transistor 21. This error amplifier 33 controls the first voltage controlling transistor 21 such that the voltages at the node B and C become equal.

The voltage at the node B equals the positive output voltage Vp minus the voltage drop across the resistor 31 (Vp−I1*R1). The voltage at the node C equals the voltage at the node B. Thus, the negative output setting voltage Vfly is given by
Vfly=Vp−I1*R1(1+R3/R2).

In this way, the negative output setting voltage Vfly becomes lower than the positive output voltage Vp by a constant voltage. It is noted that this negative output setting voltage Vfly is equal to the power supply voltage Vbat plus the voltage across the first voltage controlling transistor 21.

Referring to FIGS. 2 and 3, operation of the positive-negative output voltage supply unit will now be described. In the switching power supply circuit 70, the switch Q1 is controlled so as to bring the first detection voltage Vdet1 to the first reference voltage Vref1. Under the condition where the first detection voltage Vdet1 and the first reference voltage Vref1 are equal, the positive output voltage Vp generated has a predetermined level.

There appears at the node A either the ground potential or the positive output voltage Vp in accordance with the state of the switch Q1 being switched on or off.

A first conduction path (referred to as route) is formed in the negative output voltage generation circuit 80 when the voltage of the node A equals the positive output voltage Vp. The first route passes through the coil L1 (that is, starts from the node A having the positive output voltage Vp), second capacitor C2, third diode D3, first voltage controlling transistor 21, and power supply battery BAT (that is, a node coupled to the power supply voltage Vbat). The second capacitor C2 is charged by the current through the first route to have a polarity as shown.

The voltage across the second capacitor C2 equals the difference between the positive output voltage Vp appearing at the node A and the negative output setting voltage Vfly, which is I1*R1(1+R3/R2). That is, the second capacitor C2 is charged to this voltage as prescribed.

Since the first route is provided with the power supply battery BAT, the battery BAT is charged by the charging current that flows to the second capacitor C2 via the first voltage controlling transistor 21. As a result, excessive energy associated with the voltage that exceeds the prescribed voltage across the second capacitor C2 is recovered and stored in the power supply battery BAT.

Next, when the voltage at the node A is zero (i.e. when the switch Q1 is switched on), a second route is established through a series circuit of the ground, switch Q1, second capacitor C2, second diode D2, and third capacitor C3. The electric charge stored in the second capacitor C2 will be redistributed over the second and third capacitors C2 and C3, respectively, through the second route.

On account of charging of the second capacitor C2 by the first route and redistribution of charge over the second and third capacitor C2 and C3, respectively, by the second route, the third capacitor C3 gets (negatively) polarized as shown. As a result of repeated charging of the second capacitor C2 and redistribution of the charge stored therein, the charge stored in the second capacitor C2 gradually builds up until the capacitor C2 acquires a prescribed negative voltage (which is equal to the difference voltage given by I1*R1 (1+R3/R2). As a specific example, if the positive output voltage Vp is 15 V; negative output voltage Vn, −8 V; and power supply voltage Vbat, 3.6 V, then the negative output setting voltage Vfly will be 7 V, and the voltage drop across the first voltage controlling transistor 21 will be 3.4 V. Correctly, error voltages due to voltage drops across the diodes be taken into account in the above-mentioned voltages.

The negative voltage generated across the third capacitor C3 is outputted as the prescribed negative output voltage Vn. It is noted that the magnitude of the negative output voltage Vn is determined by the negative output setting voltage Vfly, independently of the magnitude of the positive output voltage Vp. In other words, the negative output voltage Vn is determined by the level of the constant current I1 supplied from the constant current circuit 32 and by the resistances R1-R3 of the resistors 31, 35, and 36. The magnitude of the negative output voltage Vn can be varied as needed by adjusting the magnitude of the constant current I1 and/or the resistances R1-R3.

It is noted that in this negative voltage control circuit 30 the negative output setting voltage Vfly is controlled to become lower than the positive output voltage Vp by a constant voltage, so that the second capacitor C2 is charged by the difference voltage (Vp−Vfly). As a result, it is possible to control the negative output voltage Vn to a prescribed negative voltage without detecting it. In this case, a terminal for feeding the negative output voltage Vn back to the voltage controlling IC 90 is not required, so that terminals of the voltage controlling IC 90 can be reduced in number.

Referring to FIG. 4, there is shown a second arrangement 30A of the negative voltage control circuit. As shown in FIG. 4, the negative output voltage Vn is divided by resistors 41 and 42 to obtain a second detection voltage Vdet2. The second detection voltage Vdet2 is inputted, along with a second reference voltage Vref2, into an error amplifier 43, the output of which is supplied to the gate of the first voltage controlling transistor 21. The error amplifier 43 controls the first voltage controlling transistor 21 so as to bring the second detection voltage Vdet2 to the second reference voltage Vref2, thereby, bringing the negative output voltage Vn to a prescribed level.

In the negative output voltage generation circuit 80 of FIG. 2, the first voltage controlling transistor 21 and the negative voltage control circuit 30 may be omitted. In this case, the negative output voltage Vn becomes equal to the difference between the positive output voltage Vp and the power supply voltage Vbat. Thus, the level of the negative output voltage Vn is regulated by the voltage regulator 120 as needed.

In the first embodiment, the predetermined positive output voltage Vp is generated by the switching power supply circuit 70 using the coil L1 by converting the power supply voltage Vbat. At the same time, the predetermined negative output voltage Vn is generated on the basis of the positive output voltage Vp and the power supply voltage Vbat by the negative output voltage generation circuit 80 provided between the node A of the coil L1 and the switch Q1 and a power supply voltage node having the voltage Vbat. Thus, in accordance with the level of the negative output voltage Vn, energy associated with the excessive voltage is returned to the power supply battery BAT via the first voltage controlling transistor 21. Accordingly, a proper negative output voltage Vn is generated with an improved efficiency.

In addition, the first voltage controlling transistor 21 is provided to control the level of the negative output voltage Vn. Thus, by controlling the voltage controlling transistors 21, it is possible to maintain the negative output voltage Vn at a prescribed level.

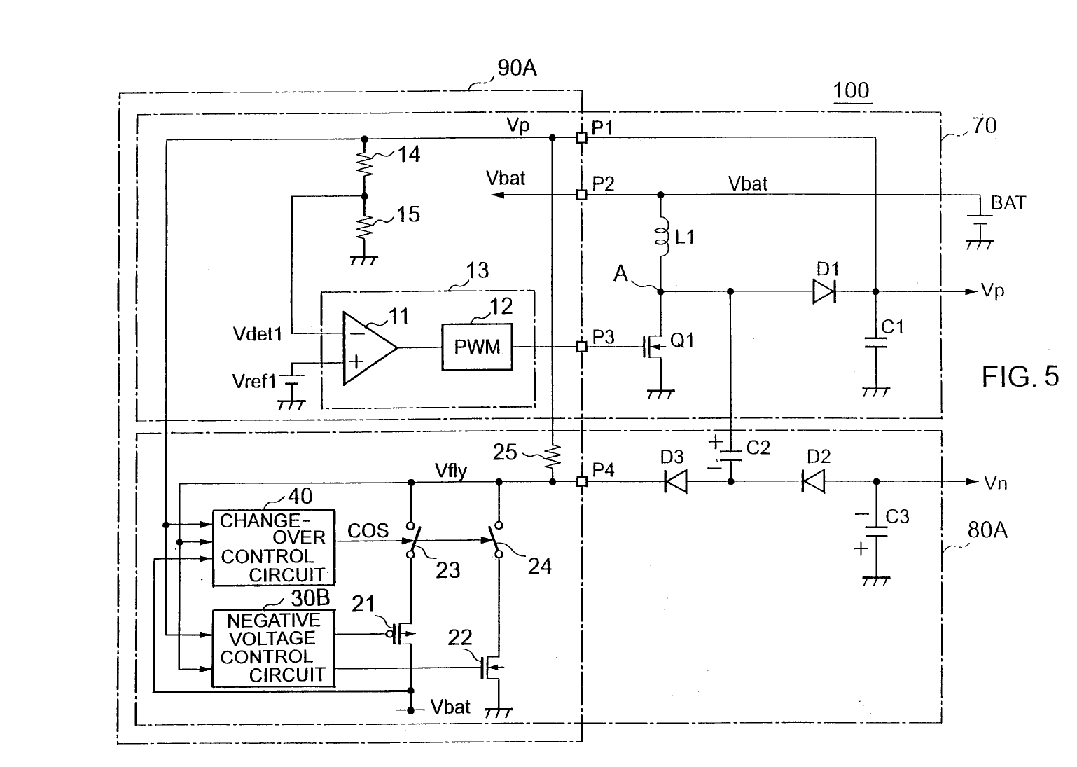

Referring to FIG. 5, there is shown an arrangement of the positive-negative output voltage supply unit 100 for generating a positive and a negative output voltage in accordance with a second embodiment of the invention. In this embodiment, a proper negative output voltage Vn can be outputted even when the voltage difference between the absolute values of the positive output voltage Vp and the negative output voltage Vn has become small. In other words, when the voltage difference has become too small to charge the power supply battery BAT, the negative output voltage Vn is outputted without charging the power supply battery BAT.

It is seen in FIG. 5 that the switching power supply circuit 70 is the same as that in the first embodiment shown in FIG. 1 but the negative output voltage generation circuit 80A is partly different from the one of the first embodiment. Differences will now be described.

In the negative output voltage generation circuit 80A, the node outputting the negative output setting voltage Vfly is connected to the power supply battery BAT via a first changeover switch 23 and a first voltage controlling transistor 21, or to the ground via a second changeover switch 24 and a second voltage controlling transistor 22 in the form of an N type MOS transistor. Either one of the first changeover switches 23 and second changeover switches 24 is selectively turned on and off by a changeover signal COS received from a changeover control circuit 40.

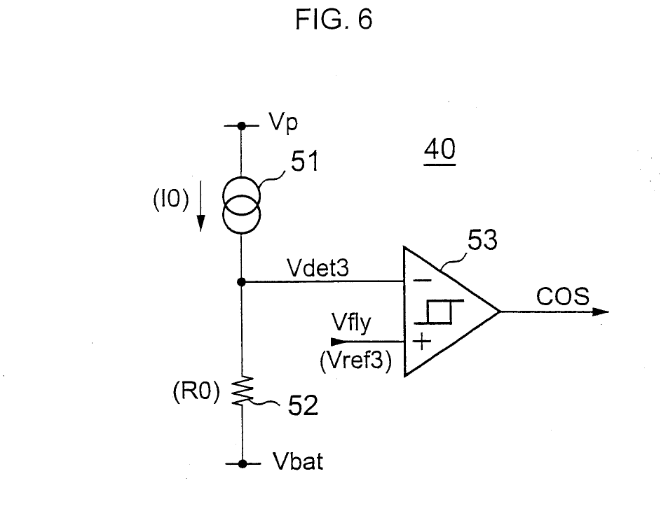

Referring to FIG. 6, there is shown an arrangement of the changeover control circuit 40. As seen in FIG. 6, there is provided between the node providing the positive output voltage Vp and the node providing the power supply voltage Vbat, a constant current circuit 51 (providing constant current I0) and a resistor 52 (having resistance R0) serially connected together in the order mentioned. A third detection voltage Vdet3 is obtained from the serial connection node of the constant current circuit 51 and the resistor 52.

The third detection voltage Vdet3 equals the sum of the power supply voltage Vbat and the voltage drop (I0*R0) across the resistor 52. The third detection voltage Vdet3 is set to a level that is sufficient to control the negative output voltage Vn while permitting charging the power supply battery BAT.

An operational amplifier 53 compares the third detection voltage Vdet3 with the negative output setting voltage Vfly, and outputs a changeover signal COS for turning on the first changeover switch 23 and turning off the second changeover switch 24 if the negative output setting voltage Vfly exceeds the third detection voltage Vdet3 (Vfly>Vdet3). On the other hand, if the negative output setting voltage Vfly is less than the third detection voltage Vdet3 (Vfly<Vdet3), the operational amplifier 53 stops the changeover signal COS to turn off the first changeover switch 23 and turn on the second changeover switch 24. In order to stabilize the respective first and second changeover switch 23 and 24 in changeover operation, the operational amplifier 53 preferably has a hysteresis characteristic.

In this way, when the difference between the positive output voltage Vp and the power supply voltage Vbat is sufficiently large, the node outputting the negative output setting voltage Vfly is connected to the power supplying node to charge the power supply battery BAT while providing a proper level of the negative output voltage Vn. On the other hand, when the positive output voltage Vp is so low, or when the power supply voltage Vbat rises so high, that the difference between them is undesirably small, the node outputting the negative output setting voltage Vfly is connected to a stable voltage node (e.g. the grounded node), thereby outputting the negative output voltage Vn having a proper level. Thus, by selectively operating the first and second changeover switches 23 and 24 according to the voltage difference, it is possible to generate a prescribed negative output voltage Vn under various voltage conditions of the power supply battery.

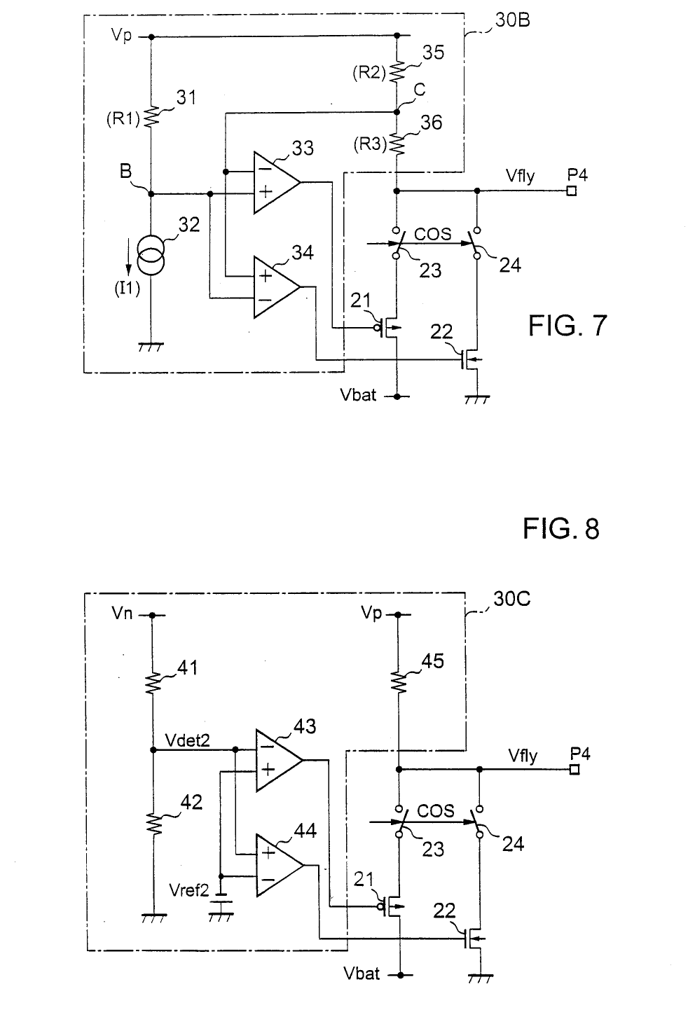

Referring to FIG. 7, there is shown a third arrangement 30B of the negative voltage control circuit in accordance with the second embodiment of the invention as shown in FIG. 5. The negative voltage control circuit 30B shown in FIG. 7 differs from the negative voltage control circuit 30 shown in FIG. 3 in that the former circuit is further provided with an error amplifier 34. The error amplifier 34 is fed with the voltages appearing at the nodes B and C. Its output is fed to the gate of the second voltage controlling transistor 22. This error amplifier 34 controls the second voltage controlling transistor 22 so as to bring the voltage at the node C to the voltage at the node B.

This negative voltage control circuit 30B operates in the same manner as the negative voltage control circuit 30 of FIG. 3 when the first changeover switch 23 is switched on. On the other hand, when the second changeover switch 24 is switch on, the negative voltage control circuit 30B causes the output of the error amplifier 34 to control the second voltage controlling transistor 22 such that the negative output setting voltage Vfly has a prescribed level.

As a consequence, the negative output setting voltage Vfly becomes lower than the positive output voltage Vp by a constant voltage, irrespective of whether the first changeover switch 23 is switched on or the second changeover switch 24 is switched on. Accordingly, if either one or both of the positive output voltage Vp and the power supply voltage Vbat change(s), the negative output voltage Vn will have a prescribed level.

Thus, the positive-negative output voltage supply unit 100 as shown in FIGS. 5-7 operates in two modes that differ only in that either the first changeover switch 23 or the second changeover switch 24 is turned on in accordance with the voltage conditions of the battery. Since the operation of the unit is substantially the same as that described in connection with FIGS. 2 and 3, further description thereof will be omitted.

Referring to FIG. 8, there is shown a fourth arrangement 30C of the negative voltage control circuit. As compared with the second negative voltage control circuit 30A of FIG. 4, the negative voltage control circuit 30C of FIG. 8 includes a further error amplifier 44. The error amplifier 44 is fed with the second detection voltage Vdet2 and second reference voltage Vref2, and supplies its output voltage to the gate of the second voltage controlling transistor 22. This error amplifier 44 controls the second voltage controlling transistor 22 so as to bring the second detection voltage Vdet2 to the second reference voltage Vref2.

When the first changeover switch 23 is turned on, this negative voltage control circuit 30C operates in the same manner as the negative voltage control circuit 30A of FIG. 4. On the other hand, when the second changeover switch 24 is turned on, the negative voltage control circuit 30C causes the second voltage controlling transistor 22 to be controlled by the output of the error amplifier 44 so that the negative output voltage Vn has a predetermined level.

As a consequence, the negative output voltage Vn is controlled to a predetermined level irrespective of whether the first changeover switch 23 or the second changeover switch 24 is turned on. Accordingly, if the positive output voltage Vp and/or the power supply voltage Vbat changes, the negative output voltage Vn has a prescribed level, as in the preceding example. It is noted that when the negative voltage control circuit 30C of FIG. 8 is used, the operational amplifier 53 of the changeover control circuit 40 is fed with a third reference voltage Vref3 having a predetermined level in place of the negative output setting voltage Vfly, as indicated in the parentheses in FIG. 6.

As described above, in the power supply unit 100 for generating a positive and a negative output voltage in accordance with any embodiment described above, the negative output setting voltage Vfly is coupled to the power supply voltage Vbat when the voltage difference between the positive output voltage Vp and the power supply voltage Vbat is sufficiently large, thereby properly generating the negative output voltage Vn while charging the power supply battery BAT. Accordingly, electric power loss in the power supply unit can be reduced, and the efficiency of the unit can be improved. On the other hand, when the positive output voltage Vp has is not sufficiently high and/or when the power supply voltage Vbat becomes very high that the voltage difference between them becomes small, the negative output setting voltage Vfly is coupled to a stable voltage node such as the ground to generate a proper negative output voltage Vn. Therefore, a required negative output voltage Vn can be properly generated under various voltage conditions of the power supply battery.

A portable device of the invention such as a CCD camera can efficiently provide required positive and negative voltages using a power supply unit 100 and can extend the usable life of a power supply battery.

As described above, the switching power supply unit of the invention is capable of efficiently generating a negative output voltage of a predetermined level along with a positive output voltage converted from a power supply voltage. The positive and negative output voltages are suitable for use with a portable device, such as a mobile telephone, having a load that requires a positive and a negative voltage.

1. A power supply unit, comprising:
a switching power supply circuit that includes a coil, a switch connected in series to said coil for cutting on and off the electric current supplied from a power supply voltage node to said coil, a rectifying and smoothing circuit for rectifying and smoothing the voltage that appears at the serial connection node of said coil and switch and for outputting the rectified and smoothed voltage as said positive output voltage, and a control circuit for controlling on-off operation of said switch so as to bring a detection voltage associated with said positive output voltage to a reference voltage; and
a negative output voltage generation circuit, connected between said serial connection node of said coil and switch and said power supply voltage node, for generating a predetermined negative output voltage based on said positive output voltage and power supply voltage.

2. The power supply unit according to claim 1, wherein said negative output voltage generation circuit comprises:
a series circuit connected in parallel to said switch, said series circuit including a second capacitor having one end connected to the serial connection node of said coil and switch, a second diode having a cathode connected to the other end of said second capacitor, and a third capacitor connected to the anode of said second diode; and a third diode having an anode connected to the node of said second diode and second capacitor, and a cathode connected to said power supplying node such that the voltage across said third capacitor is outputted as said negative output voltage.

3. The power supply unit according to claim 2, wherein a voltage controlling transistor for controlling the level of said negative output voltage is provided between the cathode of said third diode and said power supply voltage node.

4. The power supply unit according to claim 3, wherein said voltage controlling transistor is controlled so as to lower the cathode voltage of said third diode below said positive output voltage by a predetermined voltage.

5. The power supply unit according to claim 3, wherein said voltage controlling transistor is controlled so as to bring the feedback voltage associated with said negative output voltage to a predetermined voltage.

6. A power supply unit, comprising:
a switching power supply circuit that includes a coil, a switch connected in series to said coil for cutting on and off the electric current supplied from a power supply voltage node to said coil, a rectifying and smoothing circuit for rectifying and smoothing the voltage that appears at the serial connection node of said coil and switch and for outputting the rectified and smoothed voltage as said positive output voltage, and a control circuit for controlling on-off operation of said switch so as to bring a detection voltage associated with said positive output voltage to a reference voltage; and
a negative output voltage generation circuit, switchably connected, via a change-over switch circuit, between said serial connection node of said coil and switch and either one of said power supply voltage node and a stable voltage node, for generating a predetermined negative output voltage based on said positive output voltage and either one of said power supply voltage and stable voltage.

7. The power supply unit according to claim 6, wherein said negative output voltage generation circuit comprises:
a series circuit connected in parallel to said switch, said series circuit including a second capacitor having one end connected to the serial connection node of said coil and switch, a second diode having a cathode connected to the other end of said second capacitor, and a third capacitor connected to the anode of to said second diode; and
a third diode having an anode connected to the node of said second diode and second capacitor and a cathode connected to either one of said power supplying node and a stable voltage node via said changeover switch circuit such that the voltage across said third capacitor is outputted as said negative output voltage.

8. The power supply unit according to claim 7, further comprising
a first voltage controlling transistor provided between said cathode of said third diode and said power supply voltage node to control the level of said negative output voltage; and
a second voltage controlling transistor provided between said cathode of said third diode and said stable voltage node to control the level of said negative output voltage.

9. The power supply unit according to claim 8, wherein said first and second voltage controlling transistors are controlled so as to lower the cathode voltage of said third diode below said positive output voltage by a predetermined voltage.

10. The power supply unit according to claim 8, wherein
said first and second voltage controlling transistors are controlled so as to bring the feedback voltage associated with said voltage across said third capacitor to a predetermined voltage.

11. A portable device, comprising:
a power supply battery for supplying a power supply voltage;
a power supply unit according to claim 1 for generating a positive output voltage and a negative output voltage by converting said power supply voltage;
a load that utilizes said positive and negative output voltages; and
a controller for controlling said load.

12. The portable device according to claim 11, wherein said positive voltage and/or negative output voltage are/is supplied from said power supply unit to said load via a voltage regulator.
